(19) United States
(12) Patent Application Publication
(10) Pub. No.: US 2005/0054526 A1
(43) Pub. Date: Mar. 10, 2005

(54) Coated substrate and process of preparation thereof

(75) Inventors: Michael Steinke, Husum (DE); Klaus Fahrensohn, Stolzenau (DE); Martin Kraum, Nienburg (DE); Torsten Neubauer, Langenhagen (DE)

Correspondence Address: Engelhard Corporation, 101 Wood Avenue, P.O. Box 770, Iselin, NJ, 08830-0770, US

(73) Assignee: ENGELHARD CORPORATION

(21) Appl. No.: 10/926,157

(22) Filed: Aug. 25, 2004

Related U.S. Application Data
(60) Provisional application No. 60/501,136, filed on Sep. 8, 2003.

(51) Int. Cl. B05D 3/12

(52) U.S. Cl. 502/439; 427/430.1; 427/346; 427/240

(57) ABSTRACT

A substantially uniformly coated substrate that may be either metallic or ceramic in nature as well as a process for preparing such coated substrate. The substantially uniformly coated substrate typically comprises a plurality of outlets; a plurality of substrate walls; and a plurality of channels defined by the substrate walls, said channels extending directly or indirectly from at least one outlet; and wherein there are a plurality of openings and/or corrugations and/or tabs in the substrate walls that communicate between adjacent channels, said substrate containing at least one substantially uniform layer of a coating material that may be a non-sorbent, non-catalytic material; a sorbent, non-catalytic material; a catalytic material or a mixture of two or more of the foregoing materials. The process for preparing such coated substrate involves immersing the substrate in a slurry of the desired material or materials, centrifuging the substrate so as to thereby distribute the material or materials as a substantially uniform layer on the substrate and remove any material or materials in excess of that desired to be present on the substrate, and thereafter drying and calcining the coated substrate.

### CROSS-REFERENCE TO RELATED APPLICATION

This application claims the benefit of U.S. Provisional Application No. 60/501,136 filed Sep. 8, 2003, the entire contents of which are herein incorporated by reference.

### FIELD OF THE INVENTION

The invention pertains to a substrate having a substantially uniform layer of coating thereon and to a process for preparing such coated substrate. The coated substrate is useful for treating the exhaust gas stream emitted from an automotive engine, i.e., a gasoline or diesel internal combustion engine, to thereby reduce the level of unburned hydrocarbons, carbon monoxide and nitrogen oxides that may be present in such gas stream.

### BACKGROUND OF THE INVENTION

Substrates useful for the present invention are known in the prior art. Coated metal foils are also know in the prior art, e.g., see U.S. Pat. No. 5,958,829. However, the prior art substrates, particularly those that comprise metal foils containing a multiplicity of openings have not been successfully coated to date so as to create substantially uniform layers of desired non-sorbent, sorbent and/or catalytic coatings on the surfaces of such foils. Further, both ceramic and metallic substrates having high cell densities of greater than 600 cells per square inch have not been successfully coated to date with such substantially uniform layers.

Metal Foil Substrates Prior Art

The following published patent applications and patents are exemplary of various types of prior art metal foil substrates that can be coated by the process of the invention.

Published U.S. Patent Application 20030152795 pertains to a metal substrate and a method for manufacturing the same. The metal substrate is indicated as being useful for carrying a catalytic coating. A wide sheet of a metal foil is wound a plurality of times around outer peripheral surfaces of four honeycomb matrices arranged in series to form an intermediate tube, thereby forming a subassembly. A brazing filler material is wound around an outer peripheral surface of the subassembly at an end portion thereof. And the subassembly is inserted into an outer tube that is caulked to reduce an outer diameter thereof. Thereafter, heat processing is carried out in a vacuum to diffusion bond a corrugated sheet and a flat sheet, which form the honeycomb matrices, and the wide sheet of the intermediate tube to each other. The intermediate tube and the outer tube are subsequently brazed to each other.

Published U.S. Patent applications 20030152794 and 20010016266 pertain to metal foil carriers for automobile exhaust gas purification and methods of producing the same. The carrier is made of a thin metal foil composed of 8-25 μm thick corrugated metal foil and a flat metal foil joined by solder joints at least 70% of which have a thickness of 1.5-4 times the foil thickness. A honeycomb unit is formed of the corrugated and flat metal foils are joined by a solder powder having a particle diameter of not greater than 4.5 the thickness of the metal foil constituting the honeycomb unit.

U.S. Pat. No. 6,598,782 pertains to a honeycomb body and a method for manufacturing the same. The honeycomb body contains first and second metal foils having a thickness of less than 0.05 mm including a connecting point in which the metal foils are brazed to one another. The connecting point forms a wedge that is filled with the brazing medium. The metal foil connections have a thickness of less than 50 μm.

U.S. Pat. No. 6,589,670 pertains to a composite of metal foils soldered using a soldering material based upon nickel and contains 17-23 wt. % chromium, 2-10 wt. % silicon, 18-20 wt. % iron and less than 0.5 wt. % boron. The metal foils having an aluminum content of at least 6 wt. %. The metal foils are disposed in layers and/or are wound in layers to form a honeycomb body.

U.S. Pat. No. 6,458,329 pertains to a honeycomb body that is used primarily for the catalytic conversion of exhaust gases in an exhaust system, particularly exhaust system of internal combustion engines, such as diesel engines. The honeycomb body is surrounded by a smooth portion of a metal layer that extends over a part of an axial length of the honeycomb body. The layer is an integral component of the honeycomb body and is located in axial sub-regions between the honeycomb body and a jacket tube.

U.S. Pat. No. 6,576,032 pertains to a particle filter and a process for producing the filter. The particle filter is comprised of a metal foil having walls defining fluid flow channels with inlets and outlets. A first channel has an open entry cross-section at a first end side. A second channel has an open exit cross-section substantially corresponding to the entry cross-section. One of the walls of the first channel has filter passage perforations leading to the second channel. A closure in the first channel, opposite the entry cross-section, toward a second end side, closes off the first channel to the fluid. The metal foil is wound or stacked to form first and second channels in opposite directions.

U.S. Pat. No. 6,449,843 relates to a method for manufacturing a honeycomb body with a large number of fluid permeable channels. A stack is formed from a plurality of at least partly structure sheet metal layers. Each stack is folded over about a bending line such that a sheet metal pack is formed having a curved first end area and a second end area. The sheet metal packs are held by looping devices disposed in a mold, and the sheet metal pack is looped into a honeycomb body by rotation of the looping devices.

U.S. Pat. No. 6,316,121 pertains to a metal foil with through openings and a honeycomb body constructed from such metal foil. The metal foil includes at least two intersecting structures which are spaced apart from an imaginary surface and which define an intersection region. The at least two intersecting structures partially superpose one another in the intersection region and are formed with at least one through opening in the intersecting region.

U.S. Pat. No. 6,254,837 pertains to a honeycomb body for an exhaust gas catalyst. The honeycomb body has reduced thermal conductivity in the intake and outlet regions that have channels to be cross-flowed by a fluid. The body contains a section with reduced heat conductivity located near the inflow and outflow regions. The body has recesses formed in the wall of at least some of the channels.

U.S. Pat. No. 5,866,230 relates to an extruded honeycomb body of a ceramic and/or metallic material. The body includes a plurality of conduits separated from one another by partitions that extend approximately parallel to each other. The partitions are disposed and shaped in at least an outer region in such a way that, as seen in a cross-section through the body, they do not form structures that are rigid in the radial direction and/or rigid support structures extending in the circumferential direction.

U.S. Pat. No. 5,643,484 relates to an electrically heatable honeycomb body suitable for use as a carrier body for a catalytic converted. The body includes wound, stacked or otherwise layered sheet metal along which a fluid can flow in a primary flow direction, with at least some of the layers being structured. At least one layer has openings for lengthening and/or narrowing an electrically conductive path in the body. A sheet metal layer has raised locations and a periodic, undulating or trapezoidal structure with rising and falling regions.

U.S. Pat. No. 5,130,208 relates to a honeycomb body useful as a catalyst carrier body. The body includes at least partly structured metal sheets forming walls of a plurality of channels through which a fluid can flow. Some of the sheet have a primary corrugation with crests, troughs and a given corrugation height. The crests and/or the troughs have a plurality of inverted regions with a height being at most equal to the given corrugation height.

U.S. Pat. No. 4,822,766 relates to a metallic carrier foil to be coated with ceramic catalytic material. The foil is preferably electroformed and has a plurality of microscopic holes formed therein.

U.S. Pat. No. 4,753,918 relates to a metallic exhaust gas catalyst carrier body containing high temperature-resistant steel sheets forming a multiplicity of cells permeable to exhaust gas in a given exhaust gas direction. The steel sheets have slits formed therein substantially transverse to the given exhaust gas direction.

Prior Art Substrate Coating Systems and Methods

The following patents are exemplary of prior art systems and methods for coating substrates comprised of ceramics and/or metallic foils.

U.S. Pat. No. 6,478,874 relates to a system for catalytic coating of a hollow monolithic substrate. The catalyst material is coated on the substrate by immersing the substrate into a vessel containing a bath of coating slurry. A vacuum is then applied to the partially immersed substrate. The intensity of the vacuum and its application time is sufficient to draw the coating slurry upwardly from the bath into each of a plurality of channels located in the interior of the hollow substrate. After the substrate is removed from the bath, it is rotated 180°. A blast of pressurized air is applied at an intensity and for a time sufficient to distribute the coating slurry within the channels of the substrate to form a uniform coating profile therein.

U.S. Pat. No. 5,866,210 relates to a method for coating a substrate having a plurality of channels with a coating media. The substrate is partially immersed into a vessel containing a bath of the coating media with the volume of coating media lying above the end of the immersed substrate being sufficient to coat the substrate to a desired level. A vacuum is then applied to the partially immersed substrate at an intensity and time sufficient to draw the coating media upwardly from the bath into each of the channels to form a uniform coating profile therein.

U.S. Pat. No. 4,609,563 relates to a method and apparatus for coating catalytic converter substrates with an exact amount of a precious metal. The hollow substrate to be treated having opposed open ends is transferred from a starting location such that one end is lowered into a dip pan into which has been introduced a predetermined amount of a slurry material containing the precious metal. With one end immersed in the slurry, a vacuum placed on the other end draws up the entire charge of slurry from the dip pan to coat the lower portion of the substrate. Thereafter, the substrate is raised from the dip pan. The vacuum continues to operate to cause the coating to be evenly distributed on all the interior surfaces of the substrate. Then the substrate is rotated and again lowered so that the other end is immersed in another predetermined charge of the slurry and the process is repeated. Thereupon, the substrate is again raised from the dip pan. Again, the vacuum continues to operate for a predetermined time to assure even distribution of the coating. Then the substrate is again rotated to its original position and returned to its starting location.

### OBJECTS OF THE INVENTION

It is an object of the present invention to provide coating systems and methods for substantially uniformly coating substrates, particularly metal foil substrates that contain a plurality of openings and/or tabs extending upward above the surface of the foil.

It is a further object of the present invention to provide coating systems and methods for substantially uniformly coating ceramic and metallic substrates, particularly odd-shaped substrates, substrates having high cell densities, e.g., cell densities in excess of 700 cells per square inch, non-symmetrical substrates, conical substrates, substrates containing holes along their axis, and the like.

The foregoing objects and additional objects have been achieved by the practice of this invention in accordance with the description that follows.

### BRIEF DESCRIPTION OF THE DRAWINGS

FIG. 1 is an elevation view of two perforated foils substrates, the bottom metal foil substrate being a perforated flat foil and the top metal foil substrate being a corrugated perforated foil.

FIG. 1A is a photomicrograph of the bottom foil shown in FIG. 1.

FIG. 1B is a photomicrograph of the top foil shown in FIG. 1.

FIG. 2 is a cross-sectional view of a honeycomb body comprised of a flat metal foil substrate in combination with a corrugated metal foil substrate having a plurality of “tabs” that extend upward above the surface of the substrate.

FIG. 2A is a representation of the characteristics of the flow through a section of the body shown in FIG. 2

FIG. 2B and FIG. 3 are photomicrographs of an alternative version of the metal foil substrate shown in FIG. 2; in FIG. 2B and FIG. 3, the metal foil substrate is shown as having both a plurality of perforations as well as a plurality of “tabs” that extend upward above the surface of the substrate.

FIG. 4 is a cross-sectional view of three different honeycomb structures: structure A is that of a conventional honeycomb; structure B is that of a honeycomb formed from the substrate shown in FIG. 2; and structure C is that of a honeycomb formed from the substrate shown in FIGS. 2B and 3.

FIG. 5 is a photograph of the various types and sizes of tubular honeycomb bodies that can be formed from the metal foil substrates shown in one or more of FIGS. 1-3.

### SUMMARY OF THE INVENTION

The coated substrate of the invention comprises a substrate containing at least one substantially uniform layer of a coating that may be a non-sorbent, non-catalytic material; a sorbent, non-catalytic material; a catalytic material; or a mixture of two or more of the foregoing materials. The invention also pertains to substantially uniformly coated monoliths comprising openings and/or corrugations and/or tabs located at or in the walls of the cells. The invention further pertains to substantially uniformly coated monoliths having odd shapes, non-symmetrical monoliths, monoliths having cell densities in excess of 700 cells per square inch. The invention additionally pertains to process for preparing such substantially uniformly coated substrates and monoliths.

### DETAILED DESCRIPTION OF THE INVENTION

The substrate, frequently referred to in the prior art as a monolithic carrier, comprises a plurality of inlets; a plurality of outlets; a plurality of substrate walls; and a plurality of channels defined by the substrate walls, said channels extending directly or indirectly from at least one outlet; and wherein there are a plurality of openings in the substrate walls that communicate between adjacent channels. Typically, the channels are defined by walls on which the coating material is uniformly deposited so that exhaust gases flowing through the channels will contact the coating material. Typically, the channel walls are continuous without perforations or extensions from the wall surfaces, such as tabs. The channels can be of any suitable cross-sectional shape and size such as trapezoidal, rectangular, square, sinusoidal, hexagonal, oval, circular, etc. The substrate preferably comprises a honeycomb body.

In a first embodiment of the invention, the substrate comprises one or more sheets of a metal foil that typically has a thickness of about 5 to about 100 μm. Typically the foil is comprised of the same metals or metal alloys that have been used to prepare prior art metal foil substrates, e.g., titanium, stainless steel and alloys containing iron, nickel, chromium and/or aluminum. The metal foil may be utilized in one or more forms, e.g., it may be a flat, unstructured foil; it may be a structured foil, e.g., a foil containing corrugations, undulations, trapezoidal structures, ridges, etc., including corrugated foils wherein the corrugations are arranged in a serpentine or “zigzag” fashion; it may be a foil that has a plurality of openings, e.g., perforations; it may be a foil that has both corrugations and a plurality of openings; it may be a foil that has “tabs” that extend upwardly from the surface of the foil; it may be a foil that has a combination of features, e.g., corrugations, a plurality of openings and a plurality of such “tabs”, and the like.

In the case of metal foil substrates having a plurality of openings, it should be understood that for the purposes of the present invention, such openings may be in the form of slits, perforations, holes having a generally polygonal shape, holes having a generally oval shape and/or holes having a generally circular shape or combinations of two or more of the foregoing types of openings. Preferably, the openings comprise holes having a generally oval or circular shape with diameters in the range of about 2 to about 10 mm, preferably 4-8 mm. Such openings will typically comprise from about 10 to about 80%, preferably 20 to 60%, of the area of the foil.

The substrate comprises a ceramic or metal monolith having a honeycomb structure. Where the monolith is a metal monolith, the metal may be comprised of the same materials and have the same features as described above in respect to substrates of the first embodiment of the invention. Where the substrate is a ceramic, it may be a refractory material such as cordierite, cordierite-α-alumina, silicon nitride, silicon carbide, zircon mullite, spodumene, alumina-silica magnesia, zircon silicate, sillimanite, a magnesium silicate, zircon, petalite, α-alumina, and an aluminosilicate. The preferred ceramic for the second embodiment of the invention comprises cordierite.

The coating materials employed for providing the at least one substantially uniform coating layer on the substrates of the first or second embodiments are conventional in nature and are well known in the prior art. Typically, the coating material will be utilized in the form of an aqueous slurry having a solids content of about 20 to 60 wt. %, preferably, 30-45 wt. %. The coating material may comprise a non-sorbent, non-catalytic material; a sorbent, non-catalytic material; a catalytic material; or a mixture of two or more of such materials.

Exemplary non-sorbent, non-catalytic materials include zirconia, silica, silica-alumina and alumina.

Exemplary sorbent, non-catalytic materials include the zeolites, activated carbon, alkali metal oxides and alkaline earth metal oxides.

Exemplary catalytic materials include those materials which are generally referred to in the prior art as three-way conversion catalysts, since they have the capacity to treat exhaust gas streams to catalytically convert carbon monoxide into carbon dioxide, unburned hydrocarbons into carbon dioxide and water and nitrogen oxides into nitrogen. Typically, the three-way conversion catalyst comprises one or more platinum group metals disposed on a refractory metal oxide support. Suitable platinum group metals include platinum, palladium, ruthenium and the like.

The refractory metal oxide comprises a high surface area metal oxide such as alumina, titania, zirconia, mixtures of alumina with one or more of titania, zirconia and ceria. The refractory metal oxide may consist of or contain a mixed oxide such as silica-alumina, aluminosilicates which may be amorphous or crystalline, alumina-zirconia, alumina-chromia, alumina-ceria and the like. The preferred refractory metal oxide comprises gamma alumina having a BET surface area of about 60 to about 300 m²/g.

Typically, an oxygen storage component will also be present in the catalytic material. Suitable oxygen storage components include one or more oxides of a metal selected from the group consisting of cerium and praseodymium. Other oxides which may exhibit oxygen storage properties include those of iron, nickel, cobalt, a rare earth metal, an alkali metal and an alkaline earth metal. Conventional promoters and stabilizers, rare earth metal oxides, etc. may also be present in the coating materials.

The is a large body of prior art which disclose a wide variety of suitable catalytic materials, methods to prepare such materials and methods to coat such materials onto substrates. The following patents and published patent applications are exemplary of such prior art: U.S. Pat. Nos. 4,134,860; 4,438219; 4,171,288; 4,714,694; 4,727,052, 4,708,946; 4,923,842; 4,808,564; 4,438,219; 4,591,580; 4,780,447; 4,965,243; 4,504,598; and 4,587,231. More recently-issued U.S. patents include U.S. Pat. Nos. 5,202,300; 5,462,907; 5,597,771; 5,627,124; 5,968,861; 6,044,644; 6,080,377; 6,150,291; 6,171,556; as well as U.S. Published Patent Application 20030166466, EP 0 765 189 and WO 99/55459.

The coating on the substrate comprises at least one layer that is substantially uniformly coated on the substrate surfaces. Multiple substantially uniform layers of the same or different coating materials may be readily achieved by merely repeating the steps of the process of the invention the number of times desired. Moreover, the process of the invention permits the coating to be substantially uniformly deposited on the substrate as two or more adjacent zones such that the composition of the coating material in one zone differs from the composition of the coating material in an adjacent zone.

For the purposes of the present invention, the term “substantially uniform” shall be understood to mean that the thickness of the at least one substantially uniform layer varies by not more than about 10%, preferably 5% or less, throughout the substrate. Typically, each substantially uniform coating layer will have a thickness of about 10 μm to about 50 μm, preferably 20 to 40 μm.

The coating process of the invention is applicable to the preparation of the coated substrate of the first embodiment as well as to the second embodiment of the invention. The coating process involves the following steps:
(a) immersing the substrate to at least about 30%, preferably at least 50%, of its length into a vessel containing a slurry of the desired material or materials;
(b) centrifuging the substrate resulting from step (a) so as to thereby distribute the coating material or materials as a substantially uniform layer on the substrate and remove any coating material or materials in excess of that desired to be present on the substrate;
(c) drying the coated substrate resulting from step (c); and
(d) calcining the dried coated substrate resulting from step (c).

Typically, step (c) will be conducted at a temperature of about 70 to about 180° C., preferably 80 to 120° C., for about 1 to about 60 minutes, preferably 15 to 30 minutes. Step (d) will typically be conducted at a temperature of about 400 to about 700° C., preferably 450 to 550° C., for about 20 minutes to about 5 hours, preferably 30 minutes to 3 hours.

If desired, two or more different coating materials may be substantially uniformly coated on the substrate by the following variation in step (a): The substrate is immersed to about 30% to about 70% of its length in a first slurry of a coating material and the substrate is thereafter again immersed such that the remaining length is immersed in one or more other slurries of other coating materials.

The coating process of this invention has been used to substantially uniformly coat substrates having diameters of about 2 to about 6 inches in diameter and about 1.7 inches to about 4 inches in length.

The coating process of this invention lends itself to as many substantially uniform coating layers on the substrate as desired. Steps (a) and (b) may be repeated as many times as desired with the same or different coating material slurries as desired. Preferably, the coated substrate is dried after each such coating operation and most preferably, the coated substrate is both dried and calcined after each coating operation.

In general, after step (a), the substrate to be centrifuged will be oriented with its axis parallel to the radial axis of rotation of the centrifuge. The speed and time of the centrifugation in step (b) will depend various factors such as the viscosity and the solids content of the slurries of the coating materials, the substrate size and length, the cell density, i.e., the number of cells per square inch of cross section, etc. However, in general, a centrifugation rpm range of about 10 to about 1600 rpm, preferably 20 to 150 rpm, for a period of about 4 to about 30 seconds, preferably 5 to 20 seconds, is ideal for most substrates and most coating materials.

The centrifugation can be readily carried out by a centrifuge of a relatively simple design: The outer shell of the centrifuge will consist of a stainless steel vat having a bottom that is shaped in the form of a funnel. At the end of the funnel, there is an opening that communicates with a length of pipe that contains a simple on-off valve for ready removal of the slurry vehicle and excess slurry from the vat after the centrifugation has been completed. Mounted in an upper portion of the vat is a rotor, the ends of which terminate in a plurality of baskets having a plurality of openings, e.g., wire baskets. The rotor should be evenly balanced, i.e., the baskets are affixed to the ends of the rotor spaced evenly apart from each other, e.g., in diametric opposition to each other, such that counterbalancing will not be required inasmuch as a plurality of substrates, i.e., honeycomb bodies, of approximately the same size and weight are desirably simultaneously centrifuged.

The substrates that have been immersed in the desired slurries as described above are secured within the baskets and are oriented with their axis parallel to the radial axis of rotation of the centrifuge. The rotor is driven by an electric motor mounted in the center of the rotor to minimize any imbalances. The speed and time of centrifugation can be adjusted and controlled by an electrical control unit that is programmable to insure that a particular lot of substrates will be centrifuged under identical conditions.

### DETAILED DESCRIPTION OF THE DRAWINGS

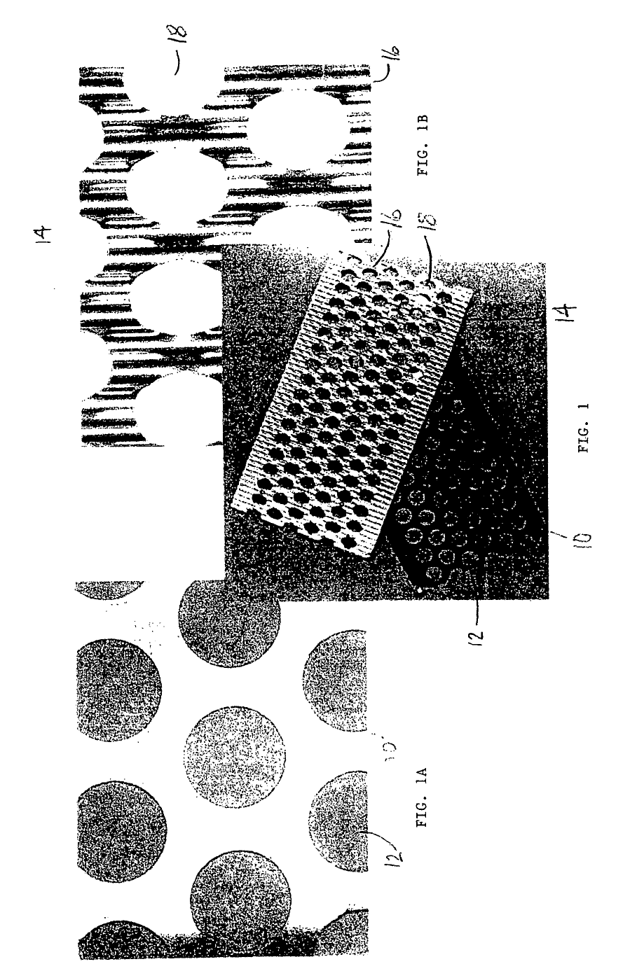

In FIG. 1, substrate 10 (the bottom substrate) is a flat metal foil containing multiple perforations 12, while substrate 14 (the top substrate) is a corrugated metal foil containing corrugations 16 and multiple perforations 18. The details of substrate 10 are more clearly shown in FIG. 1A, and the details of substrate 14 are more clearly shown in FIG. 1B.

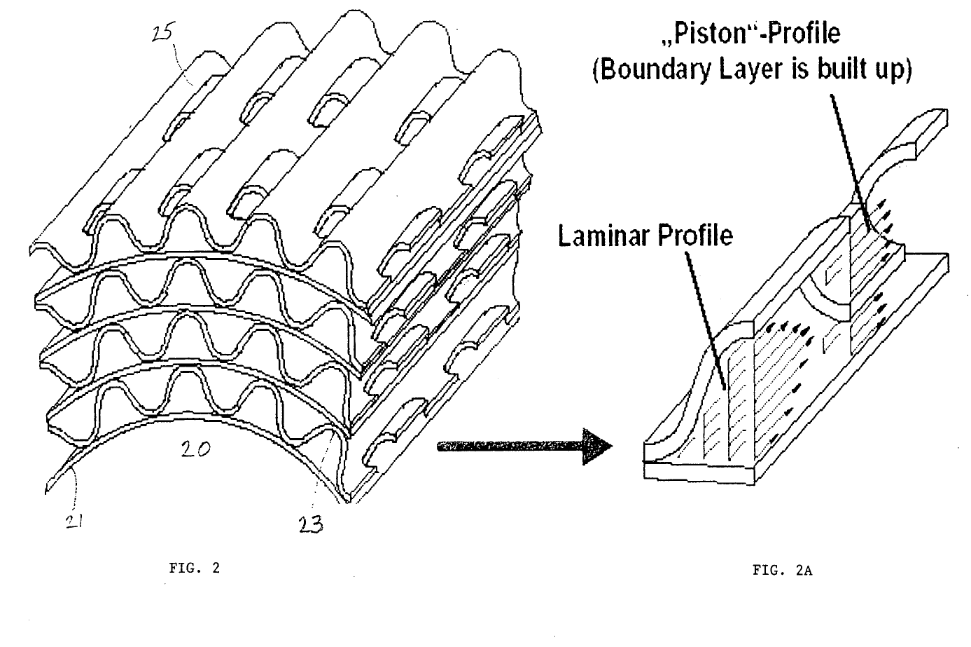

FIG. 2 is a cross-sectional view of a honeycomb body 20 containing a flat metal foil substrate 21 in combination with a corrugated metal foil substrate having a plurality of corrugations 23 and a plurality of tabs 25 that extend above the surface of the corrugated metal foil substrate.

FIG. 2A illustrates the laminar profile and the boundary profile of the flow through a section of honeycomb body 20.

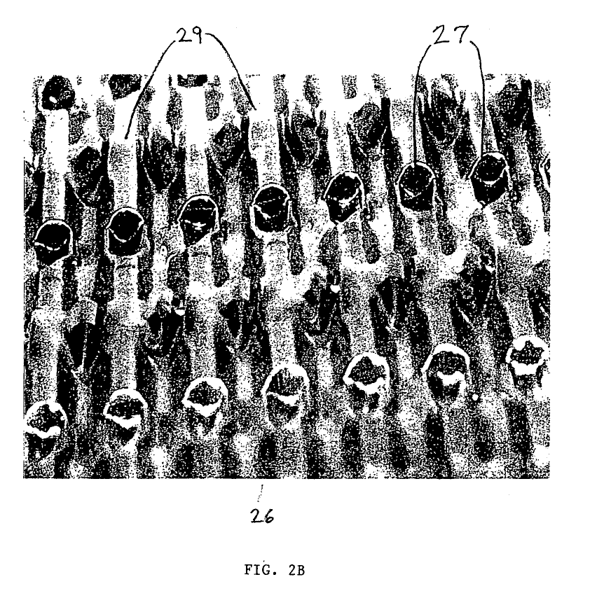

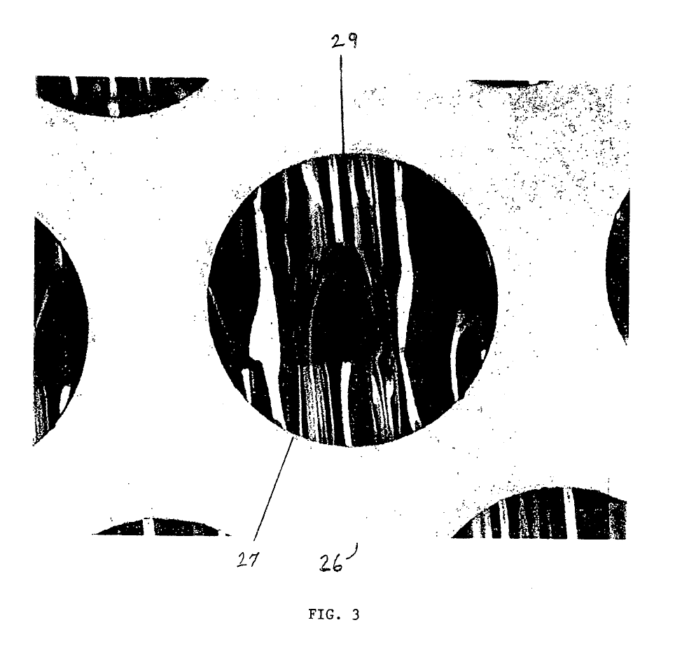

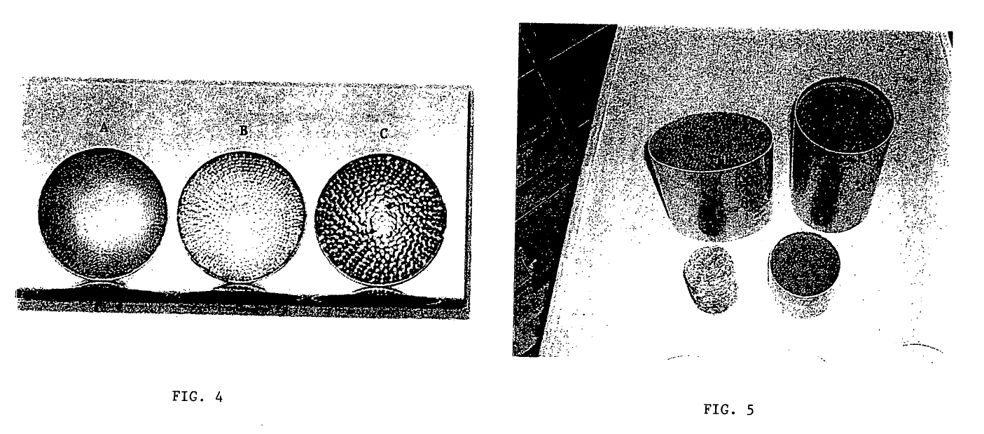

FIGS. 2B and 3 are photomicrographs of a metal foil substrate 26 containing multiple perforations 27 as well as a plurality of tabs 29 that extend above the surface of substrate 26.

1. A coated substrate comprising a substrate containing: a plurality of inlets; a plurality of outlets; a plurality of substrate walls; and a plurality of channels defined by the substrate walls, said channels extending directly or indirectly from at least one outlet; and wherein there are a plurality of openings and/or corrugations and/or tabs in the substrate walls that communicate between adjacent channels, said substrate containing at least one substantially uniform layer of a coating material selected from the group consisting of a non-sorbent, non-catalytic material; a sorbent, non-catalytic material; a catalytic material; and a mixture of two or more of the foregoing materials.

2. The coated substrate of claim 1 wherein the substrate comprises a metal foil.

3. The coated substrate of claim 1 wherein the openings comprise slits, perforations, holes having a generally polygonal shape, holes having a generally oval shape and/or holes having a generally circular shape.

4. The coated substrate of claim 1 wherein the substrate contains a plurality of tabs adjacent to the openings and extending upward from the surface of the foil.

5. The coated substrate of claim 1 wherein the surface of the substrate is corrugated.

6. The coated substrate of claim 1 wherein the non-sorbent, non-catalytic material comprises an oxide selected from the group consisting of zirconia, silica, silica-alumina and alumina.

7. The coated substrate of claim 1 wherein the sorbent, non-catalytic material comprises a zeolite, activated carbon, an alkali metal oxide and/or an alkaline earth metal oxide.

8. The coated substrate of claim 1 wherein the catalytic material comprises a three-way conversion catalyst.

9. The coated substrate of claim 1 wherein the coated substrate is disposed within a tubular member thereby forming a honeycomb body.

10. The coated substrate of claim 1 wherein the coating is present on the substrate as two or more adjacent zones such that the composition of the coating material in one zone differs from the composition of the coating material in an adjacent zone.

11. The coated substrate of claim 1 comprising a plurality of substantially uniform layers of one or more coating materials.

12. A process for applying at least one substantially uniform layer of a non-sorbent, non-catalytic material; a sorbent, non-catalytic material; a catalytic material or a mixture of two or more of the foregoing materials on a substrate comprising the steps of:
(a) immersing the substrate to at least about 30% of its length into a vessel containing a slurry of the desired material or materials;
(b) centrifuging the substrate resulting from step (a) so as to thereby distribute the material or materials as a substantially uniform layer on the substrate and remove any material or materials in excess of that desired to be present on the substrate;
(c) drying the coated substrate resulting from step (b); and
(d) calcining the dried coated substrate resulting from step (c).

13. The process of claim 12 wherein in step (a), the substrate is immersed to at least about 30% of its length in a slurry and the substrate is thereafter again immersed such that the remaining length is immersed one or more times in one or more other slurries.

14. The process of claim 12 wherein the substrate contains a plurality of inlets; a plurality of outlets; a plurality of substrate walls; and a plurality of channels defined by the substrate walls, said channels extending directly or indirectly from at least one outlet; and wherein there are a plurality of openings and/or corrugations and/or tabs in the substrate walls that communicate between adjacent channels.

15. The process of claim 12 wherein the coating is applied to the substrate as two or more adjacent zones such that the composition of the coating material in one zone differs from the composition of the coating material in an adjacent zone.

16. The process of claim 12 wherein a plurality of substantially uniform layers is coated on the substrate by repeating steps (a) through (c) after each such layer is applied to the substrate.

17. The process of claim 12 wherein step (d) is also repeated after each such layer is applied to the substrate.
